(19) United States
(12) Patent Application Publication
(10) Pub. No.: US 2003/0036011 A1
(43) Pub. Date: Feb. 20, 2003

(54) Electrophotographic color toner, color image forming method, color image forming apparatus and toner cartridge

(75) Inventors: Katsuji Ebisu, Kawasaki (JP); Yuzo Horikoshi, Kawasaki (JP); Takahiro Kashikawa, Kawasaki (JP); Katsura Sakamoto, Kawasaki (JP); Yoshimichi Katagiri, Kawasaki (JP); Yasushige Nakamura, Kawasaki (JP)

Correspondence Address: ARMSTRONG,WESTERMAN & HATTORI, LLP, 1725 K STREET, NW., SUITE 1000, WASHINGTON, DC, 20006, US

(73) Assignee: Fujitsu Limited, Kawasaki (JP)

(21) Appl. No.: 09/978,921

(22) Filed: Oct. 18, 2001

(30) Foreign Application Priority Data
Mar. 30, 2001 (JP) 2001-101169

(51) Int. Cl. G03G 9/09

(52) U.S. Cl. 430/108.1; 430/111.4; 430/124

(57) ABSTRACT

An electrophotographic color toner which can be used in a photofixing system, and is capable of realizing color toner images with good color toner fixability and vivid color tones. In addition to a binder resin, the electrophotographic color toner contains, as a colorant, a pigment having a contrast ratio within a range from 10 to 50%, as measured according to the hiding-chart test method defined in Japanese Industrial Standard JIS K5101, at least 50% of the total volume of the pigment being made up of pigment particles having a ferre equivalent circle diameter of 0.3 μm or larger.

### BACKGROUND OF THE INVENTION

1. Field of the Invention

The present invention relates to a color toner used in electrophotography, more particularly, to a color toner which is fixed on a recording medium by the use of optical energy imparted by flash light. The present invention also relates to a toner cartridge which contains the color toner of the present invention and to a color image forming method and a color image forming apparatus, which use the color toner of the present invention.

2. Description of Related Art

Electrophotography is widely employed in image forming apparatuses such as copying machines, electrophotograpic facsimile and electrophotographic printers. An electrophotographic method using a photoconductive insulator is commonly employed, as disclosed in, for example, U.S. Pat. No. 2,297,691. With this method, an electrostatic latent image is formed by irradiating with light emitted by laser, LED or the like the photoconductive insulator which is electrostatically charged by corona discharge or by means of an electrostatic charging roller. Then, a resin powder (also referred to as a developing agent) which is colored by a pigment or dye, referred to as toner, is electrostatically deposited on the electrostatic latent image, thereby developing the image to obtain a visualized toner image. The toner image is transferred onto a recording medium such as paper or film. Since the toner image at this stage consists of powder simply deposited on the recording medium, it must be fixed on the recording medium. For this purpose, a step of fixing the toner image is provided as the final step. In the fixing step, the toner is solidified after melting on the recording medium by applying heat, pressure or light. As a result, a toner image fixed on the recording medium is obtained.

As described above, fixation of the toner is a process of melting the toner which is a powder mainly consisting of a thermoplastic resin (hereinafter referred to as a binder resin) by means of heat and fixing the resin on the recording medium. Methods well known to carry out this process are a heat roll method which applies heat and pressure to the toner image formed on the recording medium directly by means of a roller, and a flash fixing method which fixes the toner on the recording medium by applying flash light emitted by a xenon flash lamp or the like.

In the flash fixing method, the toner is melted and fixed on the recording medium by converting the light energy of flash light emitted by a discharge tube such as a xenon flash lamp into heat energy. The flash fixing method, when employed in an image forming apparatus, has the following advantages over the heat roll method.

(1) The resolution of the toner powder image formed on the photoconductive insulator layer does not decrease, since fixation is carried out by a non-contact method.

(2) The process can be quick-started because a warming up period is not required after turning on the power.

(3) Fixing performance is less affected by the type of material and thickness of the recording medium such as glued paper, preprint paper and sheets paper having different thicknesses.

The toner is fixed on the recording medium by the flash fixation in the following process. Flash light emitted by the discharge tube is absorbed by the toner image (powder image) formed on the recording medium and is converted into heat energy. This causes the toner to be heated to the melting temperature and fuse with the recording medium. When flash light is turned off, the temperature decreases and the melted toner solidifies thereby to constitute a fixed toner image.

The xenon flash lamp commonly used as the discharge tube for flash fixation has a spectrum which exhibits remarkably high intensity of emission in the near infrared region of wavelengths ranging from 800 to 1100 nm and relatively low intensities of emission in the visible region ranging from 400 to 800 nm. Therefore, a toner used in the flash fixing process is required to have high light absorbance in the near infrared region. The binder resin as the main component of the toner, however, generally has very low light absorbance in the visible and near infrared regions.

Also in the case where the colorant, used as a single component, is black in color, it exhibits high absorbance in the visible and near infrared regions. However, a colorant having a color such as yellow, cyan, magenta, red, blue or green absorbs the visible light but has low light absorbance in the near infrared region. Also, a color toner consisting of a binder resin and a colorant for full color rendering is difficult to fix with flash light of an intensity sufficient to fix a black toner. Therefore, it has been necessary to supply light of higher energy to fix the color toner.

As a result, a technique has been proposed that adds an infrared absorber having light absorbance in the near infrared region as the major emitting region of the xenon flash lamp, in order to reduce the light energy required when fixing the color toner on a recording medium by flash light. For example, Japanese Unexamined Patent Publication (Kokai) Nos. 61-132959, 6-118694, 7-191492 and 2000-147824 disclose techniques of adding an aluminum salt compound, a diimonium compound or a naphthalocyanine compound to a toner to which flash fixation is applied. Also, Japanese Unexamined Patent Publication (Kokai) No. 6-348056 discloses the use of a toner having resin particles which include an infrared absorber based on such substances as anthraquinone, polymethine or cyanine in addition to the compounds described above, the particles being deposited on the surface of the toner. Japanese Unexamined Patent Publication (Kokai) No. 10-39535 describes improvement of fixability of color toner with flash light by mixing tin oxide or indium oxide therein.

The techniques disclosed in the patent publications cited above are attempts to make it easier to melt the binder resin which is the main component of the color toner by adding the infrared absorber to the color toner, thereby improving the efficiency thereof in converting light energy into heat energy.

However, any of the infrared absorbers described above absorbs light also in the visible region and has a color, thus creating a problem of affecting the color of the color toner and decreasing the color saturation. For this reason, the amount of the infrared absorber added is preferably smaller, but an insufficient amount thereof makes it difficult to fix the toner reliably with flash light. Influence of the infrared absorber on the color can be mitigated by increasing the pigment concentration, which has the effect of concealing the color of the infrared absorber. However, this may lead to a problem in that much pigment is exposed on the toner surface, thus increasing the chances of the toner being charged through friction with the pigment, instead of friction with the binder resin, leading to charge failure, making it impossible to develop the image satisfactorily.

### SUMMARY OF THE INVENTION

Under these circumstances, one object of the present invention is to provide a color toner which can realize images with vivid color tones, and particularly to provide an electrophotographic color toner which can be fixed and render vivid color tones to images on a printer which employs the flash fixation method.

Another object of the present invention is to provide a color image forming method which can form full-color images with vivid color tones by using the color toner of the present invention.

Still another object of the present invention is to provide a color image forming apparatus which can form full-color images with vivid color tones by using the color toner of the present invention.

A further object of the present invention is to provide a toner cartridge which makes it easier to handle the color toner of the present invention.

These objects and other objects of the present invention will become apparent from the following detailed description of the present invention.

In one aspect thereof, the present invention resides in an electrophotographic color toner comprising at least a binder resin and a colorant, which is used in electrophotography employing a photofixing system, in which

the electrophotographic color toner contains, as the colorant, a pigment having a contrast ratio within a range from 10 to 50%, as measured according to the hiding-chart test method defined in Japanese Industrial Standard JIS K5101,

at least 50% of the total volume of the pigment being made up of pigment particles having a ferre equivalent circle diameter of 0.3 μm or larger.

In another aspect thereof, the present invention resides in a method of forming a color image on a recording medium by means of an electrophotographic system, which comprises the steps of forming an electrostatic latent image by image exposure, visualizing the electrostatic latent image by development, transferring the visualized image onto the recording medium and fixing the transferred image, wherein

a developing agent containing the color toner of the present invention is used in the step of developing the electrostatic latent image, and

a photofixing system is used in the step of fixing the transferred image after transferring the visualized image onto the recording medium.

Furthermore, in still another aspect thereof, the present invention resides in an apparatus for forming a color image on a recording medium by means of an electrophotographic system, comprising an image exposing device for forming an electrostatic latent image, a developing device for visualizing the electrostatic latent image, an image transferring device for transferring the visualized image onto the recording medium, and an image fixing device for fixing the transferred image onto the recording medium, wherein

the developing device is provided with a developing agent containing the color toner of the present invention, and

the image fixing device is provided with a photofixing device.

Furthermore, in a further aspect thereof, the present invention resides in a toner cartridge used in an image forming apparatus in which a toner image is fixed on a recording medium by photofixation, wherein

the toner cartridge contains a developing agent containing the color toner of the present invention.

As should be apparent from the following description, according to the present invention, since the contrast ratio of the pigment incorporated as a colorant into the toner is relatively high, the influence of a colored infrared absorber on the color can be mitigated to thereby develop the original color of the pigment, thereby making it possible to realize images with vivid color tones. On the other hand, in the case of a pigment having a contrast ratio of 50% or more, it becomes impossible to obtain images with vivid color tones, because of low chroma of the pigment. In the case where 50% or less of the total volume of the pigment is occupied by pigment particles having a particle diameter of less than 0.3 μm, the transmittance becomes too high even when using a pigment having high constant ratio, thereby making it difficult to suppress the color of the infrared absorber.

### BRIEF DESCRIPTION OF THE DRAWINGS

FIG. 1 is a sectional view schematically showing a preferred example of an electrophotographic system for carrying out the image forming method employing a flash fixing system for fixing the toner;

FIG. 2 is a perspective view showing an example of a toner cartridge of the present invention; and

FIG. 3 is a light emission spectrum showing a spectral distribution of xenon flash light employed in the flash fixation method.

### DESCRIPTION OF THE PREFERRED EMBODIMENTS

The present invention can be basically applied to common electrophotographic processes, and thus it is not limited to a particular type of electrophotographic process. There is also no limitation to the developing method used in the electrophotographic process to which the present invention is applied, and a proper developing method can be freely selected and employed for each application. In other words, according to the present invention, a developing agent most suitable for the developing method to be employed can be prepared and used for the particular application, while satisfying the requirements of the color toner of the present invention. Developing methods which can be employed in the present invention include both the two-component developing system and the one-component developing system that are widely used in the art.

In the two-component developing system, toner particles and carrier particles such as magnetite, ferrite, iron powder, glass beads or resin-coated particles thereof are brought into contact with each other, with the toner being caused to deposit on the carrier particles by the use of friction charging, and the toner is then guided to a portion of a latent image to develop the image. In this system, a developing agent is constituted by combining the toner and the carrier. The particle diameter of the carrier is typically within a range from 30 to 500 μm, while 0.5 to 10% by weight of the toner particles are mixed with the carrier particles. Methods employed in this system include the magnetic brush development method.

The one-component developing system wherein use of the carrier is eliminated is also well known, being a variation of the two-component developing system. This method eliminates the need for mechanisms such as for toner concentration control, mixing and stirring, because a carrier is not used, and also makes it possible to reduce the apparatus in size. In the one-component developing system, a thin uniform film of toner is formed on a developing roller which is made of metal and an image is developed by attracting the toner to a portion of the latent image. The toner particles deposited on the developing roller can be electrostatically charged by friction charging or electrostatic induction. In the case of the one-component developing system employing friction charging, for example, a magnetic toner is used in a BMT system and FEED system which involve contact, and nonmagnetic toner is used in a touchdown system which involves contact. Details of the electrophotographic processes and the developing methods employed therein can be found in many publications dealing with the subject of the electrophotographic system.

The electrophotographic color toner of the present invention may have a composition similar to that of the color toner used in the electrophotographic system of the prior art. That is, the color toner of the present invention may be generally constituted so as to include at least a binder resin and a colorant. While various developing methods are employed in the electrophotographic system as described above, the color toner of the present invention may be either a magnetic toner which has magnetism by itself or a nonmagnetic toner, depending on the developing method employed in the intended electrophotographic processes.

In the electrophotographic color toner of the present invention, the binder resin used as the base material component is not specifically limited, although it is preferably a binder resin made of a natural or synthetic polymer substance. Preferred examples of the binder resin include polyester resin, styrene-acrylic resin, polyamide resin, polyvinyl resin, polyurethane resin, polybutadiene resin, styrene resin, acrylic resin, polyetherpolyol resin, phenol resin, siloxane resin, and epoxy resin. These binder resins may be used alone, or two or more resins may be used in combination or in the form of a composite. A linear polyester resin and a polyester resin containing a crosslinking component may also be used in combination.

The polyester resin used as the base material component can have different molecular weights according to the desired effect. The molecular weight (weight-average molecular weight) of the binder resin to realize the present invention is usually within a range from about 1,000 to 30,000, and preferably from about 2,000 to 15,000. The binder resin has a glass transition temperature of about 40 to 80° C. and a softening point of about 80 to 140° C.

The amount of the binder resin in the toner can vary depending on the desired effect, but is usually within a range from 75 to 99 parts by weight based on the total amount (100 parts by weight) of the toner.

The color toner of the present invention is characterized by the colorant to be dispersed in the binder resin.

As a first feature, the colorant used as a component in the color toner of the present invention is made of a pigment having a contrast ratio within a range from 10 to 50%, as measured according to the hiding-chart test method defined in Japanese Industrial Standard JIS K5101. In the color toner of the present invention, an infrared absorber is incorporated to allow flash fixation and, moreover, a pigment having high concealability, i.e. a pigment high constant ratio ranging from 10 to 50% is dispersed as the colorant in the toner to mitigate an adverse influence of the color infrared absorber on the color toner. Dispersion of the pigment having specific physical properties in the toner makes it possible to conceal the color of the infrared absorber used and to develop a color of the toner with an original color of the pigment.

In the present invention, the contrast ratio of the pigment was measured using the following procedure.

A vinyl chloride-vinyl acetate copolymer solution with the following composition was prepared.

| | |
|---|---|
| Vinyl chloride-vinyl acetate copolymer | 12 g |
| Ethyl acetate | 19 g |
| Ethyl isobutyl ketone (MIBK) | 25 g |
| Methyl ethyl ketone (MEK) | 39 g |

After mixing 95 g of the resulting vinyl chloride-vinyl acetate copolymer solution with 5 g of a test pigment, a dispersion treatment was conducted by a paint shaker over one hour. The resulting pigment dispersion was uniformly coated on a polyester film having a thickness of 100 μm in a dry film thickness of 20 μm, using a bar coater. After drying, a sample having a coating film of the pigment dispersion on the film surface was obtained.

The constant ratio of the resulting sample was measured by the hiding-chart test method defined in JIS K5101. After providing a white paper (reflectance: 80±1) and a black paper (reflectance: 2 or less), the sample was closely contacted with each paper and the lightness of each paper was measured from the sample side using a spectrocolorimeter (CM-3700d, manufactured by Minolta Co., Ltd.). Although the method of JIS K5101 is based on visual evaluation, the contrast ratio was specially measured by the following equation to ensure absolute accuracy.

Contrast ratio (%)=(LB/LW)×100

where LB is the lightness of a black paper and LW is the lightness of a white paper.

When the hiding power of the pigment is high, the lightness of the black paper increased, the lightness of the white paper is decreased, and thus a high contrast ratio can be obtained. On the other hand, when the hiding power of the pigment is low, the lightness of the black paper decreased because of an increased influence of the black paper, and the lightness of the white paper is increased, thus lowering the contrast ratio.

As a second feature, when the pigment used as the colorant is observed with respect to the distribution state of pigment particles, at least 50% of the total volume of the pigment is made up of pigment particles having a ferre equivalent circle diameter of 0.3 μm or larger. High hiding power can be obtained by making up almost all of the total volume of the pigment of pigment particles having comparatively large particle diameter, thereby making it possible to effectively suppress the color of the infrared absorbent used in combination.

As used herein, the term “ferre equivalent circle diameter” is one used generally in definition of the diameter of toner particles or other solid particles and is, in brief, an average diameter of diameters projected from an angle at 8 positions (0, 22.5, 45, 67.5, 90, −22.5, −45 and −67.5 degree) by a ferre diameter. In the present invention, an ultra-thin slice of toner particles was prepared and a TEM micrograph was taken. Then, image analysis of the TEM micrograph was conducted by using a dot analyzer: DA-500S (manufactured by Oji Keisoku Kiki Co., Ltd.) to determine the ferre equivalent circle diameter.

The color toner of the present invention preferably contains the pigment, as the colorant, in an amount within a range from 1 to 20 parts by weight based on the total amount (100 parts by weight) of the toner. When the amount of the pigment is within the above range, vivid color toner images and toner fixability can be simultaneously realized. When the amount of the pigment is less than 1 part by weight, it becomes difficult to suppress the color of the infrared absorber and to obtain vivid images even when using a pigment having high contrast ratio, because of the small number of pigment particles dispersed in the toner. On the other hand, when the amount of the pigment exceeds 20 parts by weight, although vivid images can be obtained, the amount of the pigment exposed on the toner surface increases, leading to charge failure due to the toner, which makes it impossible to develop the image satisfactorily.

In the practice of the present invention, although the pigment used is not specifically limited, as long as it satisfies the requirements described above, pigments shown in the following groups can be advantageously used.

C.I. Pigment Yellow 3, 12, 13, 14, 23, 55, 74, 83, 97, 112, 151, 154 and 167;

C.I. Pigment Orange 13, 16 and 36;

C.I. Pigment Red 22, 48:1. 48:2, 48:3, 48:4, 57:1, 122, 146, 170 and 202;

C.I. Pigment Violet 19 and 23;

C.I. Pigment Blue 15:1, 15:2, 15:3 and 15:4; and

C.I. Pigment Green 7 and 36.

These pigments may be used alone, or two or more pigments may be used in combination. If necessary, conventional colorants such as pigments or dyes other than those described above may be additionally used, as long as they do not exert an adverse influence on the operation and effect of the present invention.

In the color toner of the present invention, infrared absorbers are preferably used in combination to conduct photofixation more effectively and certainly. In particular, the infrared absorber is preferably one which shows a light absorption peak at a wavelength ranging from 800 to 1000 nm. This is because light emission intensity is remarkably strong at a near infrared wavelength ranging from 800 to 1100 nm in a spectral distribution of a xenon flash lamp used generally as a discharge tube for photofixation.

The amount of the infrared absorber used can vary depending on the desired effect, but is preferably within a range from 0.1 to 10 parts by weight, and more preferably from 0.1 to 3 parts by weight, based on the total amount (100 parts by weight) of the toner.

Examples of the infrared absorbing compound useful in the practice of the present invention include, but are not limited to, naphthalocyanine compounds, polymethine compounds, cyanine compounds, anthaquinone compounds, dithiol-nickel complexes, azo cobalt complexes, squarilium compounds, phthalocyanine compounds, tin oxides, lanthanoid compounds, diimonium compounds, and aminium compounds. These infrared absorbents may be used alone or, two or more infrared absorbents may be used in combination. If necessary, conventional absorbents other than those described above may be additionally used, as long as they do not exert an adverse influence on the operation and effect of the present invention.

The color toner of the present invention may contain conventional additives used in the field of color toner, in addition to the above-described toner components (binder resin, colorant and infrared absorber).

In the color toner of the present invention, waxes may be added to the binder resin. Examples of suitable wax include carnauba wax, montan wax, polyethylene wax, amide wax, and propylene wax.

For the purpose of imparting the chargeability and reducing a change in charge amount under environments of different temperature and humidity, a charge controlling agent may be added to the color toner of the present invention. The charge controlling agent is preferably a colorless or pale color charge controlling agent. As the charge controlling agent, for example, well-known positive and negative charging charge controlling agents such as a quaternary ammonium salt compound, a salicylic acid compound, a boron complex and a carboxylic acid compound can be used.

The electrophotographic color toner of the present invention can be prepared according to various procedures using the toner components described above as the starting materials. For example, the starting material is prepared by using at least a binder resin and a colorant and, preferably, an infrared absorber and optionally adding a charge controlling agent and a wax. The resulting starting material is uniformly dispersed by kneading using a pressure kneader, a roll mill, an extruder or the like. The resulting kneaded mixture is ground into fine powder with a finer grinder, a jet mill or the like, and then classified by a wind classifier that utilizes centrifugal force may be used to obtain a color toner having a desired size distribution. On kneading, the method of separately kneading an infrared absorber and a charge controlling agent with a resin and kneading both again, disclosed in Japanese Unexamined Patent Publication (Kokai) No. 7-191492, may be employed.

For the purpose of improving the fluidity, the surface of the color toner of the present invention may be coated with fine inorganic particles (hereinafter referred to as as external additive). The external additive, which can be used herein, is in the form of particles having a particle diameter within a range from 5 nm to 2 μm, and preferably from 5 nm to 500 nm. A specific surface area of the external additive as measured by the BET method is preferably within a range from 20 to 500 m²/g. The amount of the external additive to be mixed with the toner is usually within a range from 0.1 to 5 parts by weight, and preferably from 0.1 to 2.0 parts by weight, based on 100 parts by weight of the toner. Examples of a suitable external additive include fine powders of silica, alumina, titanium oxide, barium titanate, magnesium titanate, calcium titanate, strontium titanate, zinc oxide, silica sand, clay, mica, wollastonite, diatomaceous earth, chromium oxide, cerium oxide, red iron oxide, antimony trioxide, magnesium oxide, zirconium oxide, barium sulfate, barium carbonate, calcium carbonate, silicon carbide, and silicon nitride. Among these fine powders, fine silica powders are particularly preferred. The external additive is preferably used after subjecting the surface to a hydrophobization treatment.

As previously described, the color image forming method of the present invention includes the steps of:

forming an electrostatic latent image by image exposure,

visualizing the electrostatic latent image by development,

transferring the visualized image onto the recording medium, and

fixing the transferred image,

while a developing agent containing the color toner of the present invention is used, unlike a conventional method.

Also according to the present invention, in the step of transferring the image which has been visualized by the use of the developing agent onto the recording medium and then fixing the image, the photofixing system is employed to fix the toner. Flash light can be advantageously used in the photofixation of the transferred toner image. The flash light may have wavelengths selected from a broad region reaching near infrared as well as the visible region, in accordance with the specifications of the flash fixing device to be used. A xenon lamp can be used to generate the flash light to efficiently fix the toner. The light omission energy density, i.e. light intensity, of the xenon lamp is preferably within a range from 1.0 to 6.0 J/cm² in terms of energy density per unit area in a single flash. An energy density of light emission of less than 1.0 J/cm² is unable to fix the toner and an energy density of higher than 6.0 J/cm² may burn the toner and/or paper. The energy density: S (J/cm²) of light emission is given as follows.

S=((1/2)×C×V²)/(u×l)/(n×f)

where n is the number of lamps, f is the lighting frequency (Hz), V is the input voltage, C is the capacitance of a capacitor (μF), u is the process speed (mm/s) and 1 is a width of the print (mm).

Although the emission time of the flash light may be widely varied according to the energy density of flash light, it is preferably in a range from 500 to 3,000 μ/s. Too short a flashing time of the flash light may be unable to melt the toner sufficiently to increase the fixing rate. Too long a flashing time of the flash light may, on the other hand, cause overheating of the toner which is fixed on the recording medium.

More specifically, the color image forming method of the present invention may be carried out in a manner similar to the image forming method of the prior art, except for the differences described above. By way of a preferable example, formation of an electrostatic latent image by image exposure can be carried out, after uniformly charging the surface of a photoconductive insulator such as a photosensitive drum with positive or negative electrostatic charge, by partially erasing the electrostatic charge deposited on the insulator by irradiating the photoconductive insulator with light in the pattern of the image with any of various means, thereby leaving the electrostatic latent image remaining. For example, the surface charge can be erased from particular portions by irradiating with laser beam, so as to form the electrostatic latent image on the photoconductive insulator according to the image information.

Then, the electrostatic latent image thus formed is visualized by development. This can be done by depositing the fine powder of the developing agent, which includes the toner of the present invention, on the latent image portion where the electrostatic charge remains on the photoconductive insulator.

After the developing step, the visualized image is transferred onto the recording medium. This can be generally done by electrostatically transferring the toner image onto the recording medium, such as recording paper.

Finally, the transferred toner image is melted and fixed on the recording medium by the flash fixing method according to the present invention to obtain an intended duplicate (print or the like).

The method of forming color images based on electrophotography is well known in this technical field and accordingly description thereof will be omitted herein.

The color image forming apparatus of the present invention, typically the electrophotographic apparatus, is also well known in this technical field and accordingly description thereof will be omitted herein.

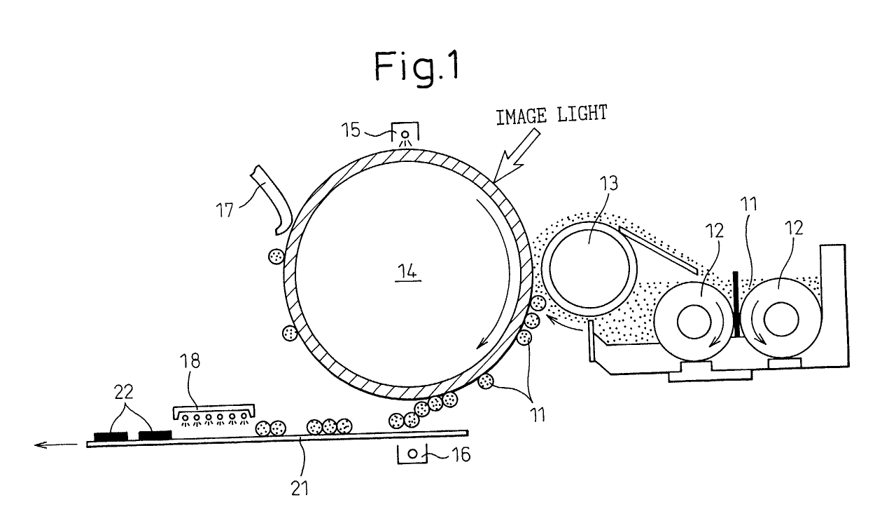

For reference, an example of an electrophotographic apparatus which can be advantageously used in the present invention is shown in FIG. 1.

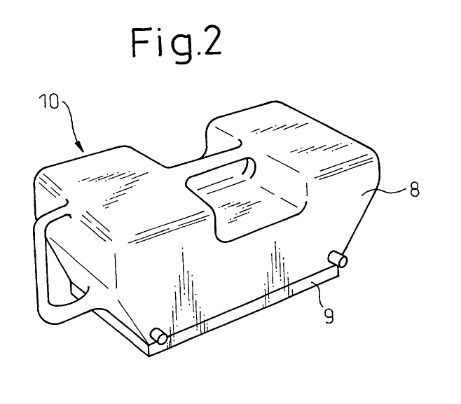

In the electrophotographic apparatus shown in FIG. 1, a developing agent 11 prepared by mixing the color toner of the present invention is supplied from a toner cartridge 10 shown schematically in FIG. 2. The toner cartridge 1 is composed of a toner container 8 made of plastic and is sealed with a cap 9. The developing agent 11 is stirred with a stirring screw 12 so as to effect friction charging. The developing agent 11 which is charged by friction is guided through a predetermined circulation path via a developing roller 13 to reach a photosensitive drum 14. The photosensitive drum 14 may be constituted from a photosensitive material which has photoconductivity, for example, an organic photosensitive material such as polysilane, phthalocyanine, phthalopolymethine or an inorganic photosensitive material such as selenium and amorphous silicon, or an insulating material, depending on the method of forming the latent image. A photosensitive material made of amorphous silicon is particularly preferable in view of the long lifetime thereof.

The surface of the photosensitive drum 14 which has received the developing agent 11 transferred thereto is electrostatically charged by a preliminary charger 15 located behind the drum in the rotating direction thereof, while the electrostatic latent image is formed thereon by the image light, i.e. light applied by an exposure device (not shown) according to the image. The preliminary charger 15 may comprise a corona discharging mechanism such as a corotron or scorotron, or a contact charging mechanism such as a brush charger. The exposure device may be constituted by using various optical systems as the light source, such as a laser optical system, an LED optical system or a liquid crystal optical system. Thus, the developing agent 11 which has been charged and transferred to the photosensitive drum 14 is deposited on the drum surface in the area of electrostatic latent image, thereby forming the visualized toner image.

The toner image 11 formed on the photosensitive drum 14 is moved onto the transfer section 16 and is transferred onto a recording medium (paper, film, etc.) 21. The transfer section 16 may have various constitutions, depending on the type of force used in the transfer process, such as electrostatic force, mechanical force or viscous force. In the case where electrostatic force is used, for example, corona transferring device, roll transferring device, belt transferring device or the like can be employed.

The recording medium 21 is guided in the direction of the arrow, so that the toner image is fixed thereon below the flash fixing device 18. The toner image on the recording medium 21 is heated by the flash fixing device 18 so as to melt and penetrate into the recording medium 21 thereby to be fixed. When the fixing step is completed, a fixed image 22 is obtained.

Toner which is left without being used in the transfer step in the toner image 11 on the photosensitive drum 14 is decharged by a decharger (not shown) and removed from the surface of the photosensitive drum 14 by a cleaning device (blade in the illustrated case) 17. The cleaning device may be, besides a blade, a magnetic brush cleaner, an electrostatic brush cleaner or a magnetic roller cleaner.

### EXAMPLES

The following Examples further illustrate the present invention in detail. It should be noted, however, that the present invention is not limited to these Examples.

Preparation of Color Toner

As shown below, a total of eleven kinds of color toners were prepared.

### Example 1

| | | | |
|---|---|---|---|
| Binder resin | Polyester resin (NCP-001J, | 91 | parts by |
| | manufactured by NIPPON CARBIDE | | weight |
| | INDUSTRIES CO., INC.) | | |
| Infrared absorber | Aminium compound (NIR-AM1, | 1 | parts by |
| | manufactured by Teikoku Chemical | | weight |
| | Industries Co., Ltd.) | | |
| Colorant | Copper phthalocyanine pigment | 5 | parts by |
| | (contrast ratio: 30%, volume of pigment | | weight |
| | having particle diameter of 0.3 μm or | | |
| | more: 80%, Linol Blue ES | | |
| | manufactured by TOYO INK MFG., | | |
| | Inc.), C.I. Pigment Blue 15:3) | | |
| Negative charging | E-89 (manufactured by Orient Chemical | 2 | parts by |
| controlling agent | Industries, Ltd.) | | weight |

The materials described above were charged in a Henschel mixer for preliminary mixing and then the mixture was kneaded in an extruder. The kneaded mixture was ground by a hammer mill and then ground into fine powder in a jet mill. The fine powder thus obtained was classified by an air flow classifier, thereby to obtain fine particles colored in blue having a volume-average particle diameter of 8.5 μm. To the fine particles of toner thus obtained, 0.5 parts by weight of hydrophobic fine silica particles (H2000/4 manufactured by Clariant Japan Co., Ltd.) were externally added in the Henschel mixer. As a result, the surface of the blue toner was coated with the external additive.

### Example 2

The same procedure as in Example 1 was repeated, except that the colorant of the color toner for preparation of a red toner was changed to the following in this example.

| | | | |
|---|---|---|---|
| Colorant | Red pigment (contrast ratio: 30%, volume of | 5 | parts by |
| | pigment having particle diameter of 0.3 μm or | | weight |
| | more: 50%, KET Red 338 manufactured by | | |
| | DIC, C.I. Pigment Red 57:1) | | |

### Example 3

The same procedure as in Example 1 was repeated, except that the colorant of the color toner for preparation of a green toner was changed to the following in this example.

| | | | |
|---|---|---|---|
| Colorant | Green pigment (contrast ratio: 35%, volume of | 5 | parts by |
| | pigment having particle diameter of 0.3 μm or | | weight |
| | more: 60%, KET Green 201 manufactured by | | |
| | DIC, C.I. Pigment Green 7) | | |

### Example 4

The same procedure as in Example 1 was repeated, except that the amount of the colorant: copper phthalocyanine pigment was changed to 20 parts by weight from 5 parts by weight in this example.

### Example 5

The same procedure as in Example 1 was repeated, except that the amount of the colorant: copper phthalocyanine pigment was changed to 5 parts by weight from 1 part by weight in this example.

### Example 6

The same procedure as in Example 1 was repeated, except that incorporation of the infrared absorber: aminium salt compound was omitted in this example.

### Comparative Example 1

The same procedure as in Example 1 was repeated, except that the colorant of the color toner was changed to the following for comparison in this example.

| | | | |
|---|---|---|---|
| Colorant | Yellow pigment (contrast ratio: 9%, | 5 | parts by |
| | manufactured by HOECHST) | | weight |

### Comparative Example 2

The same procedure as in Example 2 was repeated, except that the volume of the red pigment having a particle diameter of 0.3 μm or larger was changed to 40% for comparison in this example, and a toner colored magenta was prepared.

### Comparative Example 3

The same procedure as in Example 2 was repeated, except that the amount of the red pigment was changed to 0.8 parts by weight from 5 parts by weight for comparison in this example.

### Comparative Example 4

The same procedure as in Example 1 was repeated, except that the amount of the colorant: copper phthalocyanine was changed to 21 parts by weight from 5 parts by weight for comparison in this example.

### Comparative Example 5

The same procedure as in Example 1 was repeated, except that the colorant: copper phthalocyanine was changed to the following and used in the same amount in this example.

| | |
|---|---|
| Colorant | Blue pigment (contrast ratio: 55%, MILORI BLUE NBB-2A, |
| | manufactured by Dainichiseika Color & Chemicals Mfg. Co., |
| | Ltd.) |

Color Toner Printing Test

The color toner prepared in the above examples was set in a flash fixing type printer designed for a two-component developing agent, and a toner image was formed on a recording medium, and then the fixability was evaluated. As the two-component developing agent, a mixture of 4.5 parts by weight of the resulting color toner and 95.5 parts by weight of a silicone resin-coated magnetite carrier (manufactured by Kanto Denka Kogyo Co., Ltd.) prepared in a ball mill was used.

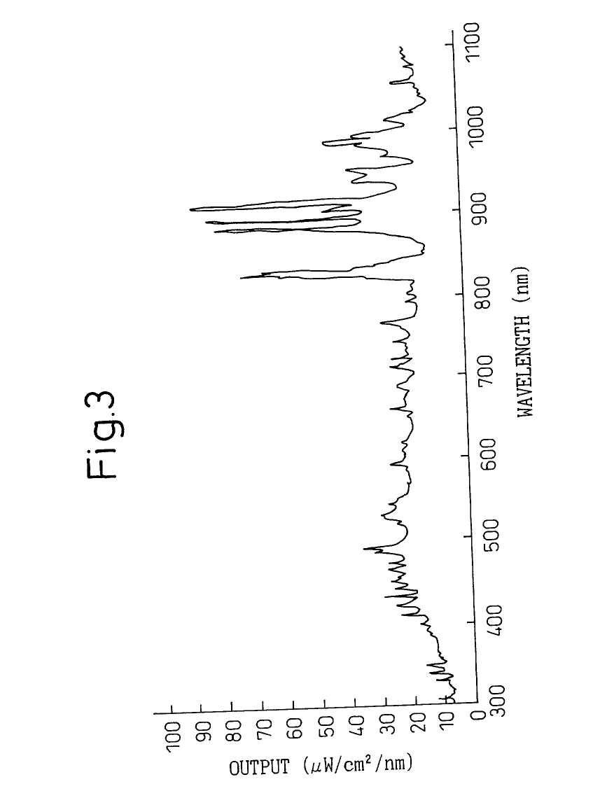

Using a laser printer employing a xenon flash fixation system (article No. F6760D, manufactured by FUJITSU), a powder image of the color toner was solidified after being melted on a paper to obtain a fixed image. The light emission spectrum of a xenon light source mounted in a flash fixing machine is as schematically shown in FIG. 3. The light emission energy density was 4.5 J/cm² and the light emission time was 1000 μ/s. The color tone of each fixed image was visually observed and the vividness of the color was rated according to the following five-rank criteria.

5 . . . excellent

4 . . . good

3 . . . ordinary

2 . . . poor

1 . . . very poor

Subsequently, each fixed image was subjected to the evaluation test with respect to the following items. Fixability of toner:

The optical density (status A density) of each fixed image was measured first. Then, after lightly sticking an adhesive tape (Scotch™ Mending Tape manufactured by Sumitomo 3M) on the lines printed on the same paper, a cylinder made of steel 100 mm in diameter and 20 mm in width was rolled over the tape in contact therewith, and then the tape was pulled off. Then, the optical density of the lines printed on the paper from which the tape was removed was measured again. The percentage of optical density after removing the tape compared to the optical density before removing the tape (100%) was calculated and recorded as the fixation (%) of toner.

The fixability of each toner was rated from the fixation (%) of the toner according to the following five-rank criteria.

| | |
|---|---|
| Below 50%: | score 1 |
| From 50% to below 70%: | score 2 |
| From 70% to below 80%: | score 3 |
| From 80% to below 90%: | score 4 |
| 90% or higher: | score 5 |

A fixing rate of 70% or higher means that the toner has practical, useful fixability: Charging stability:

After printing 10,000 sheets of paper, the resulting prints were checked to see whether fogging (background staining) had occurred or not and the charging stability was rated according to the following five-rank criteria.

5 . . . excellent (no fogging)

4 . . . good (very slight fogging)

3 . . . ordinary (slight fogging)

2 . . . poor (impermissible quantity of fogging)

1 . . . very poor

The results of the above evaluation tests are summarized in Table 1 below.

TABLE 1

| | Features | Color tone | Vividness | Fixability | |
|---|---|---|---|---|---|
| Examples | | | | | Charging stability*¹ |
| 1 | Specific blue pigment | Blue | 4 | 4 | 4 |
| 2 | Ratio of pigment particles having a | Red | 4 | 3 | 4 |
| | diameter of 0.3 μm is 50% by volume | | | | |
| 3 | Specific green pigment | Green | 4 | 4 | 4 |
| 4 | Concentration of pigment is 20 parts | Blue | 3 | 4 | 3 |
| | by weight | | | | |
| 5 | Concentration of pigment is 1 part | Blue | 3 | 4 | 4 |
| | by weight | | | | |
| 6 | No absorber is added | Blue | 5 | 3 | 4 |
| Comp. | | | | | |
| Examples | | | | | Charging stability |
| 1 | Contrast ratio is less than lower limit | Yellow | 2 | 4 | 4 |
| 2 | Ratio of pigment particles having a | Red | 1 | 4 | 4 |
| | diameter of 0.3 μm is less than lower | | | | |
| | limit | | | | |
| 3 | Concentration of pigment is less than | Red | 2 | 4 | 4 |
| | lower limit (1 part by weight) | | | | |
| 4 | Concentration of pigment exceeds upper | Blue | 2 | 4 | 2 |
| | limit (20 parts by weight) | | | | |
| 5 | Different pigment is used | Blue | 2 | 4 | 4 |

*1evaluated from the amount of fogging after printing 10,000 sheets of paper

As will be understood from the results of the evaluation tests in Table 1, in Examples 1 to 5, the original color of the pigment could be developed and a vivid color tone could be achieved. On the other hand, in Comparative Examples 1 to 3, as a result of an influence exerted on the color of the infrared absorber, the original color of the pigment could not be developed and vivid images could not be obtained. In Comparative Example 4, good images could not be obtained because of charge failure of the toner. In Comparative Example 5, good images could not be obtained because of lowering of the vividness of the toner.

As described above, according to the present invention, there can be provided an electrophotographic color toner which can be used in a photofixing system for fixing images, and is capable of realizing color toner images with good color toner fixability and vivid color tones.

Also, according to the present invention, there can be provided a color image forming method, a toner cartridge and an color image forming apparatus, which effectively use the color toner of the present invention and fully achieve the effects thereof.

1. An electrophotographic color toner comprising at least a binder resin and a colorant, which is used in combination with a photofixing system, which contains, as the colorant, a pigment having a contrast ratio within a range from 10 to 50%, as measured according to the hiding-chart test method defined in Japanese Industrial Standard JIS K5101,
at least 50% of the total volume of the pigment being made up of pigment particles having a ferre equivalent circle diameter of 0.3 μm or larger.

2. The electrophotographic color toner according to claim 1, further comprising an infrared absorber which exhibits a light absorption peak at a wavelength ranging from 800 to 1000 nm.

3. The electrophotographic color toner according to claim 1 or 2, which contains the pigment in the amount of 1 to 20 parts by weight based on the total amount of the toner.

4. The electrophotographic color toner according to claim 1 or 2, wherein the pigment is at least one pigment selected from the group consisting of:
C.I. Pigment Yellow 3, 12, 13, 14, 23, 55, 74, 83, 97, 112, 151, 154 and 167;
C.I. Pigment Orange 13, 16 and 36;
C.I. Pigment Red 22, 48:1. 48:2, 48:3, 48:4, 57:1, 122, 146, 170 and 202;
C.I. Pigment Violet 19 and 23;
C.I. Pigment Blue 15:1, 15:2, 15:3 and 15:4; and
C.I. Pigment Green 7 and 36.

5. The electrophotographic color toner according to claim 2, wherein contains the infrared absorber is contained in the amount of 0.1 to 10 parts by weight based on the total amount of the toner.

6. The electrophotographic color toner according to claim 2, wherein the infrared absorber is at least one pigment selected from the group consisting of naphthalocyanine compounds, polymethine compounds, cyanine compounds, anthaquinone compounds, dithiol-nickel complexes, azo cobalt complexes, squarilium compounds, phthalocyanine compounds, tin oxides, lanthanoid compounds, diimonium compounds, and aminium compounds.

7. A method of forming a color image on a recording medium by means of an electrophotographic system which comprises the steps of forming an electrostatic latent image by image exposure, visualizing the electrostatic latent image by development, transferring the visualized image onto the recording medium and fixing the transferred image, wherein
a developing agent containing a color toner, which comprises at least a binder resin and a colorant and contains, as the colorant, a pigment having a contrast ratio within a range from 10 to 50%, as measured according to the hiding-chart test method defined in Japanese Industrial Standard JIS K5101, at least 50% of the total volume of the pigment being made up of pigment particles having a ferre equivalent circle diameter of 0.3 μm or larger, is used in the step of developing the electrostatic latent image, and
a photofixing system is used in the step of fixing the transferred image after transferring the visualized image onto the recording medium.

8. The color image forming method according to claim 7, wherein the color toner further comprises an infrared absorber which exhibits a light absorption peak at a wavelength ranging from 800 to 1000 nm.

9. The color image forming method according to claim 7 or 8, wherein the pigment is contained in the amount of 1 to 20 parts by weight based on the total amount of the toner.

10. The color image forming method according to claim 7 or 8, wherein the pigment is at least one pigment selected from the group consisting of:
C.I. Pigment Yellow 3, 12, 13, 14, 23, 55, 74, 83, 97, 112, 151, 154 and 167;
C.I. Pigment orange 13, 16 and 36;
C.I. Pigment Red 22, 48:1. 48:2, 48:3, 48:4, 57:1, 122, 146, 170 and 202;
C.I. Pigment Violet 19 and 23;
C.I. Pigment Blue 15:1, 15:2, 15:3 and 15:4; and
C.I. Pigment Green 7 and 36.

11. The color image forming method according to claim 8, wherein the infrared absorber is contained in the amount of 0.1 to 10 parts by weight based on the total amount of the toner.

12. The color image forming method according to claim 8, wherein the infrared absorber is at least one pigment selected from the group consisting of naphthalocyanine compounds, polymethine compounds, cyanine compounds, anthaquinone compounds, dithiol-nickel complexes, azo cobalt complexes, squarilium compounds, phthalocyanine compounds, tin oxides, lanthanoid compounds, diimonium compounds, and aminium compounds.

13. An apparatus for forming a color image on a recording medium by means of an electrophotographic system, comprising an image exposing device for forming an electrostatic latent image, a developing device for visualizing the electrostatic latent image, an image transferring device for transferring the visualized image onto the recording medium, and an image fixing device for fixing the transferred image onto the recording medium, wherein
the developing device is provided with a developing agent containing a color toner, which comprises at least a binder resin and a colorant and contains, as the colorant, a pigment having a contrast ratio within a range from 10 to 50%, as measured according to the hiding-chart test method defined in Japanese Industrial Standard JIS K5101, at least 50% of the total volume of the pigment being made up of pigment particles having a ferre equivalent circle diameter of 0.3 μm or larger, and
the image fixing device is provided with a photofixing device.

14. The color image forming apparatus according to claim 13, in which the color toner further comprises an infrared absorber which exhibits a light absorption peak at a wavelength ranging from 800 to 1000 nm.

15. The color image forming apparatus according to claim 13 or 14, in which the pigment is contained in the amount of 1 to 20 parts by weight based on the total amount of the toner.

16. The color image forming apparatus according to claim 13 or 14, wherein the pigment is at least one pigment selected from the group consisting of:
C.I. Pigment Yellow 3, 12, 13, 14, 23, 55, 74, 83, 97, 112, 151, 154 and 167;
C.I. Pigment Orange 13, 16 and 36;
C.I. Pigment Red 22, 48:1. 48:2, 48:3, 48:4, 57:1, 122, 146, 170 and 202;
C.I. Pigment violet 19 and 23;
C.I. Pigment Blue 15:1, 15:2, 15:3 and 15:4; and
C.I. Pigment Green 7 and 36.

17. The color image forming apparatus according to claim 14, in which the infrared absorber is contained in the amount of 0.1 to 10 parts by weight based on the total amount of the toner.

18. The color image forming apparatus according to claim 14, wherein the infrared absorber is at least one pigment selected from the group consisting of naphthalocyanine compounds, polymethine compounds, cyanine compounds, anthaquinone compounds, dithiol-nickel complexes, azo cobalt complexes, squarilium compounds, phthalocyanine compounds, tin oxides, lanthanoid compounds, diimonium compounds, and aminium compounds.

19. The color image forming apparatus according to claim 13 or 14, wherein the photofixing system is used at a light emission energy density ranging from 1.0 to 6.0 J/cm².

20. A toner cartridge used in an image forming apparatus in which a toner image is fixed on a recording medium by photofixation, wherein
the toner cartridge contains a developing agent containing a color toner, which comprises at least a binder resin and a colorant and contains, as the colorant, a pigment having a contrast ratio within a range from 10 to 50%, as measured according to the hiding-chart test method defined in Japanese Industrial Standard JIS K5101, at least 50% of the total volume of the pigment being made up of pigment particles having a ferre equivalent circle diameter of 0.3 μm or larger.
